(19) United States
(12) Patent Application Publication
(10) Pub. No.: US 2024/0146795 A1
(43) Pub. Date: May 2, 2024

(54) SHARING CONTACT INFORMATAION

(71) Applicant: Dmitri Dozortsev, Houston, TX (US)

(72) Inventor: Dmitri Dozortsev, Houston, TX (US)

(21) Appl. No.: 18/400,917

(22) Filed: Dec. 29, 2023

Related U.S. Application Data
(63) Continuation-in-part of application No. 14/540,848, filed on Nov. 13, 2014.
(60) Provisional application No. 61/939,527, filed on Feb. 13, 2014.
(60) Provisional application No. 61/932,353, filed on Jan. 28, 2014.
(60) Provisional application No. 61/928,856, filed on Jan. 17, 2014.
(60) Provisional application No. 61/903,728, filed on Nov. 13, 2013.
(60) Provisional application No. 63/538,982, filed on Sep. 18, 2023.

(51) Int. Cl. H04L 67/01

(52) U.S. Cl. CPC H04L 67/01; G06K 7/1417

(57) ABSTRACT

An approach for transmitting information from a first device to a second device is disclosed. Entries are selected from a dataset on the first device. A representation of the selected entries are embedded in an image. The image is scanned by a camera on the second device to extract the representation of the selected entries. The representation of the selected entries are stored on the second device.

### STATEMENT REGARDING PRIOR DISCLOSURES BY THE INVENTOR OR A JOINT INVENTOR

The following disclosure is submitted under 35 U.S.C. 102(b)(1)(A): DISCLOSURE: “General Number Blue (GNB)” by Dmitri Dozortsev. Released as a downloadable product on Feb. 15, 2023.

If an Application Data Sheet (ADS) has been filed for this application, it is incorporated by reference herein. Any applications claimed on the ADS for priority under 35 U.S.C. §§ 119, 120, 121, or 365 (c), and any and all parent, grandparent, great-grandparent, etc. applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application is related to and/or claims the benefit of the earliest available effective filing date(s) from the following listed application(s) (the “Priority Applications”), if any, listed below (e.g., claims earliest available priority dates for other than provisional patent applications or claims benefits under 35 USC § 119(e) for provisional patent applications, for any and all parent, grandparent, great-grandparent, etc. applications of the Priority application(s)). In addition, the present application is related to the “Related Applications,” if any, listed below.

### PRIORITY APPLICATIONS

For purposes of the USPTO extra-statutory requirements, the present application constitutes a utility application related to and claims the benefit of priority from U.S. Provisional Patent Application Ser. No. 61/939,527 filed Feb. 13, 2014; and U.S. Provisional Patent Application Ser. No. 61/932,353 filed Jan. 28, 2014; and U.S. Provisional Patent Application Ser. No. 61/928,856 filed Jan. 17, 2014; and U.S. Provisional Patent Application Ser. No. 61/903,728 filed Nov. 13, 2013; the contents of which are incorporated herein by reference in their entirety.

### BACKGROUND

The present invention relates to sharing information, and more particularly to allow a user to select information to send in a selectable means for transmitting the selected information.

### SUMMARY

According to an embodiment of the present invention, there is a method for transmitting data between a first device and a second device. Entries are selected from a dataset on the first device. A representation of the selected entries are embedded in an image. The image is scanned by a camera on the second device to extract the representation of the selected entries. The representation of the selected entries are stored on the second device.

According to an embodiment of the present invention, there is an information handling system performing the steps of the method for transmitting data between a first device and a second device.

According to an embodiment of the present invention, there is A computer program product that performs the steps of the method for transmitting data between a first device and a second device.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention will be apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 is a flowchart of a user registering with an application capable of implementing embodiments of the invention disclosed herein;

FIG. 2 is a schematic diagram of a user profile created during or after the user registration with the application;

FIG. 3 is a schematic diagram of user specific data;

FIG. 4 is a flowchart of a method of sharing a document according to embodiments of the invention;

FIG. 5 is a schematic diagram illustrating an overall view of communication devices, computing devices, and mediums for implementing embodiments of the invention;

FIG. 6 is a flowchart of a method for sharing information between networked devices according to embodiments of the invention;

FIG. 7 is a schematic diagram of a method for sharing information between devices according to embodiments of the invention;

FIG. 8 is a schematic diagram of an artificial intelligence assistance of the application user interface facilitating selection of items to share; and

FIG. 9 depicts a schematic view of a processing system wherein the methods of this invention may be implemented.

### DETAILED DESCRIPTION

Contact information exchange is a common practice for individuals and professionals, often involving sharing names, addresses, companies, emails, and phone numbers. Existing methods rely on manual entry or digital platforms that require internet connectivity.

There is often a need to exchange information between people who are not subscribers on the same network (i.e., Skype®¹ or Viber), or do not have each other's cell phone number, or for a number of reasons do not want to share their phone number. A good example is a phone call placed from a cell phone to a customer support agent on a land line. The customer support agent in this case will have access to the Internet, but unless the calling customer has the customer support email address, there is no venue to send information electronically to the agent. In order to provide an email address, the caller to customer support has to supply the customer support agent with the email by spelling the email out over the phone. Such spelling is highly inaccurate and even if email address is captured correctly, the whole process is cumbersome and manual. ¹Skype is a registered trademark of Microsoft Corporation,

Furthermore, when a customer contacts a company for the first time or does not remember their account number, they are usually asked to provide their name, phone number, address, and other identifiable information. Providing information by the customer usually requires repeated spelling of their name and address, which once again takes valuable time and can be frustrating and prone to errors.

Thus, there exists a need for a time efficient method and system to securely share information while eliminating errors prior to communicating parties sharing their contact information or when such sharing is impossible or impractical.

In order to overcome the deficiencies of prior art, there is a need for a more versatile and flexible solution that allows users to choose between offline and online contact information transfer methods. The present invention relates to the field of contact information exchange, in an embodiment a software application is provided that allows users to exchange itemized contact information using either an encoded image scanning offline method or an internet-based cloud storage method.

In an embodiment of the present invention, a software application, General Number Blue (GNB) enables users to create profiles with multiple entries of contact information. GNB may offer two options for contact information exchange: an offline method using encoded images such as Quick Response (QR) codes and an online method utilizing cloud storage for interchanging information. The user can select the preferred method based on their circumstances and preferences. GNB may include additional features such as encryption to ensure the security and privacy of the transferred contact information. It may also offer options for customizing the appearance and design of the generated QR codes.

In an embodiment, the disclosed software application provides an innovative approach to itemized contact information exchange by offering users the flexibility to choose between an offline scan image-based method, a direct transfer method, and an online cloud storage method. GNB enables efficient and secure transfer of contact information, catering to different user preferences and scenarios. In this disclosure, GNB is assumed to be installed on the machines performing the functions described herein. and users are accessing support provided by GNB as needed.

In one embodiment of the present invention, GNB is installed and executed on a sender's device, such as a smartphone for a computer. The sending user creates a profile by entering multiple contact information entries, including names, addresses, companies, emails, and phone numbers. GNB allows the user to customize and organize the contact information entries as per their preference. The QR code is presented on the sender's device's display, ready to be scanned by the recipient's device. The receiving user may also install GNB on one or more receiving user's machines. When the recipient scans the QR code using their device, a QR code processing application executing on the recipient's device extracts the embedded contact information. The recipient's device can then store the received contact information in the desired location, such as the device's address book or a dedicated contacts database or execute GNB which puts the information in a format used for exchanging information. In some embodiments, the information in the QR code is encrypted and decryption utilizes an algorithm internal to GNB to decrypt the information in order to decode the information.

In the case of the online transfer method, a unique session ID is assigned to a session where the selected contact information is transmitted from the sender's device to the cloud storage system, securely associated with the unique session ID. The unique session ID is displayed on the sender's device's display for the recipient to scan. After scanning the unique session ID using their device, the recipient's software application establishes a connection to the cloud storage system using the session ID. The recipient's software application retrieves the contact information associated with the session ID from the cloud storage system, enabling the recipient to access and store the received contact information.

In an embodiment, a method of information exchange is disclosed. The method registers an end-point device of a sending user (SU) in a networked database by issuing a Unique ID (UID) for the end-point device of the SU. The SU enters information into the end-point device of the SU and supplies the UID to a receiving user (RU). The RU enters the UID into the end-point device of the RU, a web browser, smartphone or another end-point device database interface to generate a query requesting the information from the end-point device of the SU. The information is then transmitted to the end-point device of the RU.

In an embodiment, a method for electronic transfer is disclosed between a sender user networked device of a sending user (SU), and a receiving user (RU) is provided with information of the SU stored on the sender user networked device. The sender user networked device is then registered in a networked database by the issuance of a Unique ID (UID) for the electronic transaction, the UID being reserved and unavailable to others while the electronic transaction is pending. The UID is displayed on the sender user networked device. The SU supplies the UID to the RU in various ways such as orally. The RU enters the UID into a receiving user networked device or a web browser or another device interfaced with the database. A query requesting the information from the sender user networked device is generated in response to the RU entry of the UID, with the query displayed on the SU device. The SU then authorizes transmitting of the information in response to the query. The information is then transmitted to the receiving user networked device or the web browser. The electronic transaction between the sender user networked device and the RU is thus completed.

A method for electronic payment between a sending user networked device of a sending user (SU) and a receiving user (RU) is provided that includes payment information being entered and stored on the sending user networked device. The sending user networked device in is registered with a networked database by issuance of a Unique ID (UID) for the transaction, which is reserved and unavailable to other while the transaction is pending. The UID on the is displayed sending user networked device. The SU supplies the UID to the RU orally or through a separate route of electronic communication. Upon receipt of the UID, the RU enters the UID into a receiving user end-point device or a web browser connected to the database to create an authorization query to the sending user networked device. The query is displayed on the sending user networked device. The SU selects payment information on the sending user networked device and authorizes the transaction on the sending user networked device. Electronic payment information is then transmitted to the RU. A system for performing the method includes a server connected via a network to the end-point networked device of the SU and the end-point networked device of the RU. A memory system in electrical communication with the server containing a machine readable medium and having stored thereon one or more sequences of instructions which, when executed by a processor, cause the method to be carried out.

The present invention may be used to provide information to customer support, login into a web site, complete a web form, send a file, make a payment, and receive an appointment while never disclosing any permanent contact information about the sender if desired. A link to GNB may be provided on the web site to GNB to enable GNB support. In some embodiments, it may also be useful to transfer information into a mobile device from any medium.

Embodiments of the present invention has utility as a system and method to share information in a secure and time efficient manner while eliminating spelling and information transfer errors. Embodiments of the inventive system provide a convenient way to securely exchange subsets of information in real time between individuals and businesses. Embodiments of the inventive system are also useful for making a payment using a credit card or a bank account, logging into a web site, and under any other circumstances when information needs to be transferred between two network devices that are not uniquely identified on the same network (such as two Skype users who each must have an account on Skype network to communicate). Embodiments of the inventive information sharing platform enable a user to confirm in real time their intention to transfer information from their networked device to another specific user device and verify the identity of that user in real time before allowing the transfer to begin.

A software application executing on a sender's device receives a profile or a dataset including multiple entries of contact information associated with a user. Each entry is represented by a discrete, non-divisible set of alphanumeric characters representing a name, email, address, weblink etc, or an image. One or a group of entries can be chosen from the profile for each exchange. A group of chosen entries can also be stored on the sender's device with the assigned group's name for future exchanges so that there is no need to choose the entries for each transaction. For exchanges using a network a unique temporary session ID is generated by the application and is displayed on the sender's device. The session ID can be a number or an image. The numerical session ID is transmitted to the recipient verbally, in person or over a transmission medium, while the image presentation of the session ID is presented on the sender's device. The unique session ID is received by the application running on a recipient's device. The software application executing on the recipient's device connects to the cloud storage system using the unique session ID. The software application executing on the recipient's device retrieves the contact information associated with the unique session ID from the cloud storage system. For exchanges not using the network, the chosen entries are embedded into the image for reading by the camera of the recipient's device and extracting embedded entries for storage on the recipient device. Those entries that can be matched to the generic fields of the contact may be labeled as vCard. A group that is stored on a sender's device can be shared.

According to one embodiment of the invention, there is provided a method that includes a processor and a local storage device accessible by the processor for exchanging of contact information. A software application executing on a sender's device receives a profile or a dataset including multiple entries of information associated with a user. A user interface (UI) is provided that allows a user to select specific entries from the multiple entries on a first device to share with a receiving user on a second device. After the user utilizes the UI and selects entries, an image is constructed including the selected entries on the first device. The image may be received by the second device, for example, by scanning the image using a camera. In some embodiments the image may be a QR code which generic support available for decoding the image. Alternatively, the image may be received via Bluetooth or via near field communication (NFC). Once the image is received, the image may be decoded and stored on the second device. In some embodiments, the decoded data may be recognized as contact information and stored in a contact list. In some embodiments, some entries in the data may be kept in a proprietary format tailored to an application that receives the data and other entries may be in a recognizable and standard format, for example, in a Virtual Contact File (VCF) or VCard.

As used herein, an end user device is a personal computer, smart phone, tablet, or another end-point networked device that can store information.

In a specific embodiment of the present invention, a transfer of information may be accomplished as follows: A sending user (SU) that intends to send information provides a recipient user (RU) with a unique identifier (UID) for the information that the SU wants to send. The identifier is readily transmitted by email, voice over the phone, text message, mail, encoded by sound over the phone, or by any combination of such techniques. The unique identifier may be a numeric or alphanumeric string. In certain inventive embodiments, the unique identifier is a phone number, randomly generated number, or a number selected by the sending user; letters, picture, a sound, a bar-code, or a combination thereof. The recipient user (RU) enters the received unique identifier into their end-point device that triggers an automated request to the sending user to allow the information to be transferred. Upon receiving the automated request for sending information, the sending user who is authorized to grant the request either accepts or rejects the request. If authorization is granted, the information is transferred to the recipient user. In some inventive embodiments, SU authorization is not required and information transfer proceeds to the RU. For an added level of security, the request or unique identifier may have a time-limit, determined by a sending party and expires, once the limit is reached if the sending user has not acted on the request. In certain inventive embodiments, the information transfer is direct thereby avoiding copies remaining on intermediate servers that are prone to security lapses. Such a direct transfer is ideal for the transmission of sensitive personal and financial information, and as such is particularly well suited for financial and medical information exchange. Specific examples of a request may involve at least one of attending an appointment, returning a defective product, transferring funds, exchanging merchandise, or exchanging software, etc.

When embodiments of the inventive method to securely share information are implemented as an email or email add-on, the sending user is asked whether they want to send regular email or “secure email”. If the sending user chooses, “secure email”, the receiving user is sent an email which only contains a UID for the information to be sent. Upon receiving, the add-on email, the receiving user's computer transforms the UID into an executable command which generates a request to the sending user to obtain the actual information contained in the email. Alternatively, the receiving user may be required to use other means to request information from the sender such as calling the sending user on the phone to request the information using that UID. This may be desirable in a case where the sending user wants to be sure that the receiver is actually the one requesting information. In some inventive embodiments, once the UID of the information is sent to the receiving user, the information itself may be temporarily moved or copied from the sending user's computer to the cloud or to a phone or any other device selected by a sending user. The UID can also be transmitted orally during a call between the SU and RU. Once the authorization is granted, the information is moved to the receiving user from the cloud, phone, or any of the other devices that have the information. In certain embodiments, the information is deleted from the cloud following the transfer of information to the receiving user.

Unlike file sharing or instant messaging, the communicating parties (sending user, receiving user) do not necessarily need to be registered in the same network (such as Skype or Facebook users) and may remain completely anonymous. When the need to exchange information arises, one of the users generates a UID. When the receiving user enters the sending user's UID into the database, the sending user receives a notice that the receiving user is attempting to access the sending user's information, and the sending user has the option to authorize or decline the request. The sending user has also an option to define a subset of its data to which access is authorized and define the duration of the access. In certain inventive embodiments, the information transfer is automatically terminated with the end of the phone call or another predetermined event occurs.

It is noted that the sending and/or receiving users or parties may be individuals, businesses, or automated or computerized entities, such as a voice response system with voice recognition, or a web site in any pairing combination. Embodiments of the inventive information sharing platform may be Internet based and accessed via a website with a graphical user interface (GUI) such as a browser. In a specific inventive embodiment, a sending user may choose from a list the kind and type of information to authorize to be sent to the receiving user.

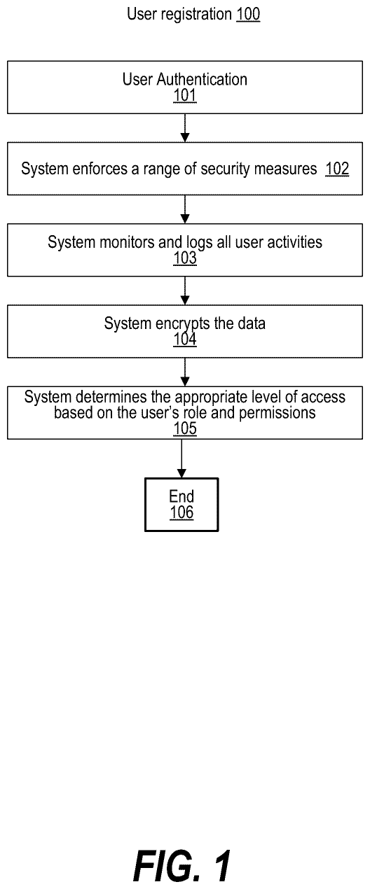

FIG. 1 shows taken by a user registration process 100. At step 101, the user is authenticated. This may involve supplying identification, submitting personal information, and even video authentication. At step 102, the system enforces a range of security measures which may include, for example two factor authentication. At step 103, the system may monitor and log all user activities. The activity may be associated with a user profile created when the user successfully registers and included in a knowledge base (KB). At step 104, the system encrypts any sensitive information or data pertaining to the user. At step 105, the system determines the appropriate level of access based on the user's role and permissions. In cases where a user does not have administrator authority the user may only change data pertaining to the user. FIG. 1 processing thereafter ends at 106.

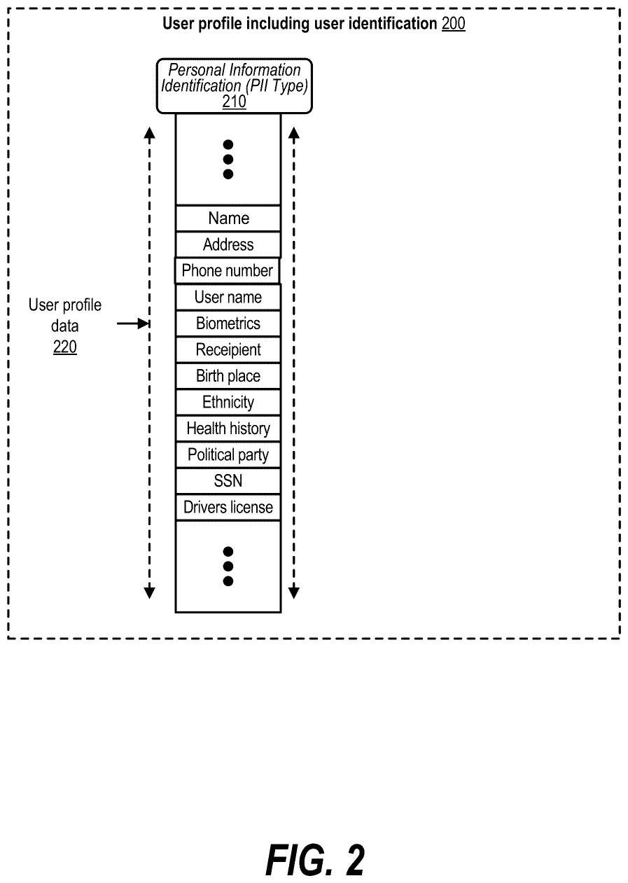

FIG. 2 depicts a representation of a user profile data which includes user identification 200. In an example embodiment, a user profile data infrastructure pointer 220 points to a structure that identifies a Personal Information Identification Type (PII) 210. In many cases, the information and sensitivity of fields in the user profile data are known, such as, when the user fills out a form. In some embodiments, the data may be included via other approaches. The user may define the category by entering a label or selecting a category and providing the data related to the category or label. The data may be entered directly or copied from a file. Internally some number of categories may be assigned an identifying number followed by the data which could be in a string field. In some cases, sensitivity classification may be provided utilizing a field recognition. Many distinct types of categories may be supported, such as, but not limited to, not sensitive, sensitive personal based on discovery, mild sensitive personal, medium sensitive personal, extremely sensitive personal, business sensitive, business confidential, and the like. There are many ways that the information may be classified and/or identified. In some embodiments the fields may be known based on a template in a form, a user classification, a scan using regular expression, and etc. Having personal information available in one or more files related to a single person may change or affect the sensitivity of the information in the files. For example, being able to identify the specific person for which the information refers may be considered highly sensitive depending on how the data is used. The sending user may utilize the user interface provided by the application to identify the sensitivity of the data and its default usages.

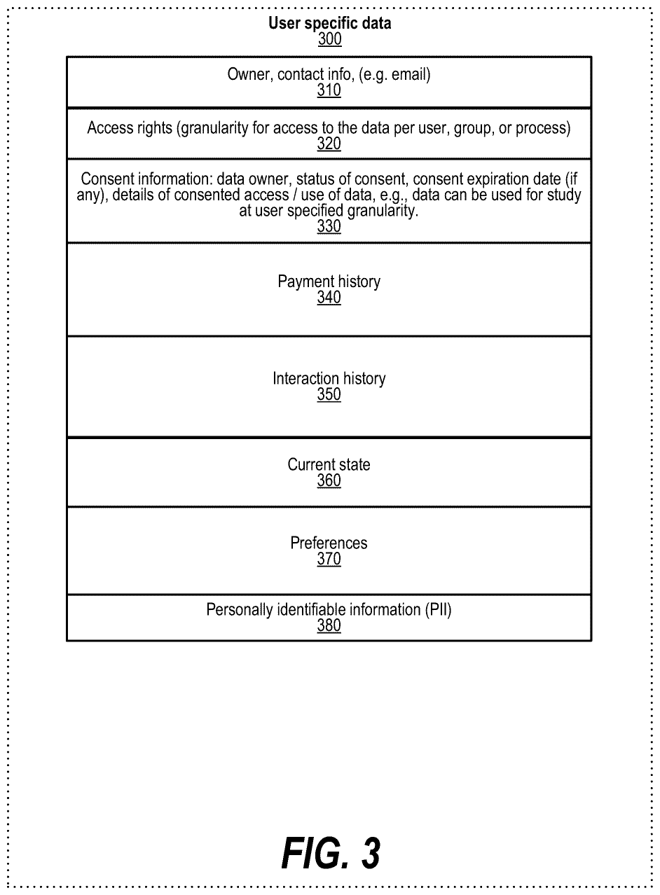

FIG. 3 depicts a high level representation user specific data 300. The data includes: User's contact information, e.g. email 310. Access rights (granularity for access to the data per user, group, or process) 320. Consent information: data owner, status of consent, consent expiration date (if any), details of consented access/use of data, e.g., data can be used for preestablished purposes at specified granularity 330. Payment history 340. Interaction history 350. Current state 360, for example, awaiting transfer of data approved. Preferences 370, for example, prefers instant messages. Personal identifiable information (PII) 380 which includes discovery and mapping details. In an embodiment, all access to file data is audited, such that, when a selected file is accessed, the auditing information records information related to accessing the selected file, who accessed the selected file, when the selected file is accessed and any actions performed on the selected file. The consent information includes a purpose for which the personal data can be used, a date that an authorization was given by the data owner, and a date of the expiration. The selected file may be deleted automatically after the date of the expiration. The system may automatically adjust the user specific data based on current contents in the file and a current consent information of the data owner/user.

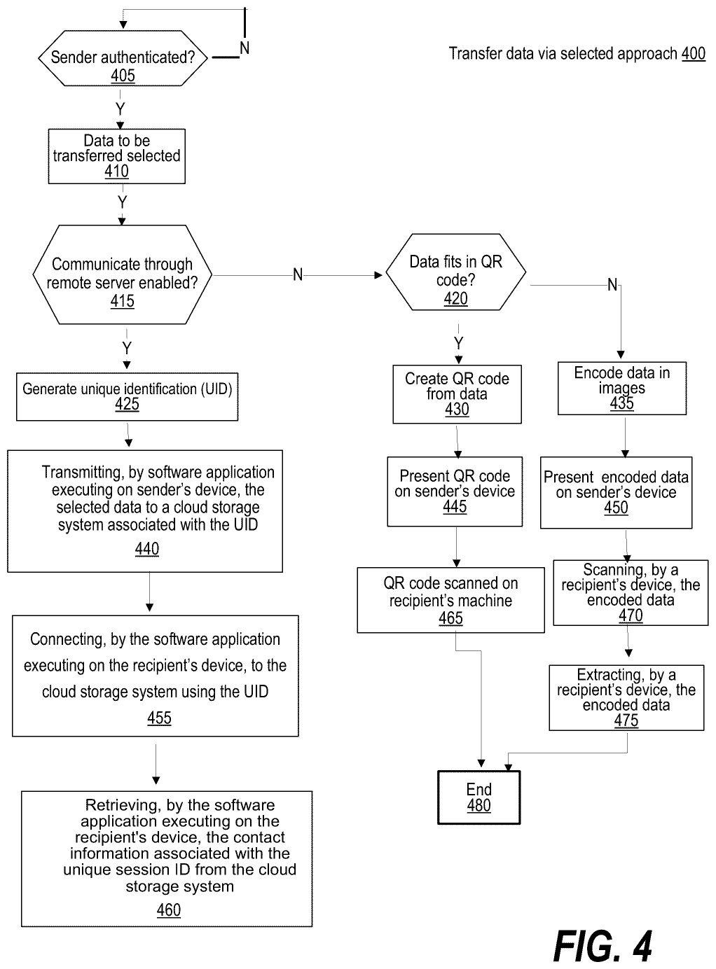

FIG. 4 depicts an exemplary embodiment of the invention disclosed herein. The process determines as to whether sender authenticated (decision 405). If not sender authenticated, then decision 405 branches to the ‘N’ branch which loops back to 405. This looping continues until sender is authenticated, at which point decision 405 branches to the ‘Y’ branch exiting the loop. At step 410, the process determines the data to be transferred. This may be done, by a graphical user interface (GUI) where user selectable information is presented. The user may select previously entered information or may add new entries by identifying a label for the selection and a value for the selection. Various approaches may be used to identify the information or data to be sent. For example, the user may upload a file providing directions to follow to obtain the information to send or have a form filled out. The process determines as to whether communicate through remote server enabled (decision 415). If communicate through remote server enabled, then decision 415 branches to the ‘Y’ branch. On the other hand, if not communicate through remote server enabled, then decision 415 branches to the ‘N’ branch. The process determines as to whether data fits in QR code (decision 420). If data fits in QR code, then decision 420 branches to the ‘Y’ branch. On the other hand, if not data fits in QR code, then decision 420 branches to the ‘N’ branch. At step 425, the process generates a unique identification (UID). The UID may be, for example, a random number chosen with a predetermined number of digits. In one embodiment, the number is chosen by the application running on a sender's machine and sent to a cloud server. If the cloud server currently has an active session with the same UID, it may reject the session request in which case the application may generate a new UID and restart a session until the session is accepted. Alternatively, the cloud server may generate the UID and return the generated UID to the application running on the sender's machine when the session to the cloud server is enabled. The UID may be sent to the receiving user via a separate means. At step 430, the process creates QR code. At step 435, the process encodes data in images. At step 440, the process transmits, by software application executing on sender's device, the selected data to a cloud storage system associated with the UID. At step 455, the process connects, by the software application executing on the recipient's device, to the cloud storage system using the UID. At step 465, the QR code is scanned on recipient's machine. At step 470, the encoded data is scanned by a recipient's device. At step 475, the process extracts, by a recipient's device, the encoded data. At step 460, the process retrieves, by the software application executing on the recipient's device, the contact information associated with the unique session ID from the cloud storage system. FIG. 4 processing thereafter ends at 480.

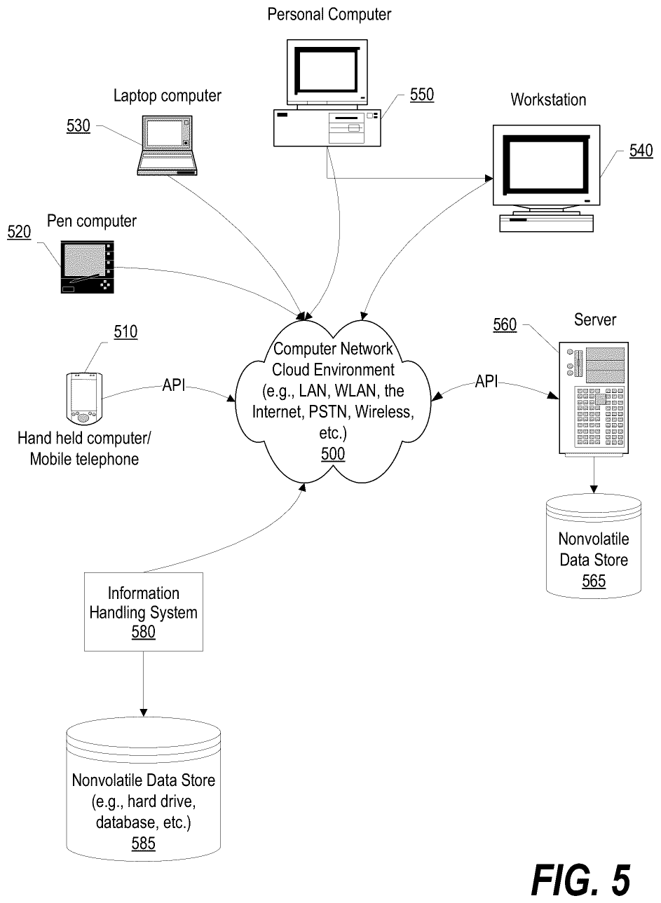

As shown, cloud computing environment 500 comprises one or more cloud computing nodes with which local computing devices used by cloud consumers, such as, for example, personal digital assistant (PDA) 510 or cellular telephone 510, desktop computer 550, laptop computer 530, and/or other mobile device such as an automobile computer system may communicate by sending and receiving data as needed. Nodes in the computer network 500 may communicate with one another. They may be grouped (not shown) physically or virtually, in one or more networks, such as Private, Community, Public, or Hybrid clouds as described hereinabove, or a combination thereof. This allows cloud computing environment 500 to offer infrastructure, platforms and/or software as services for which a cloud consumer does not need to maintain resources on a local computing device. It is understood that the types of computing devices shown in FIG. 5 are intended to be illustrative only and that computing nodes in cloud computing environment 500 can communicate with any type of computerized device over any type of network and/or network addressable connection (e.g., using a web browser). Types of computer networks that can be used to interconnect the various information handling systems include Local Area Networks (LANs), Wireless Local Area Networks (WLANs), the Internet, the Public Switched telephone Network (PSTN), and others. Examples of handheld computer 510 include personal digital assistants (PDAs), personal entertainment devices, such as MP3 players, portable televisions, and compact disc players. Other examples of information handling systems include pen, or tablet, computer 520, laptop, or notebook, computer 530, workstation 540, personal computer system 550, and server 560 archival storage systems 565, etc. Other types of information handling systems that are not individually shown in FIG. 5 are represented by information handling system 580 shown with nonvolatile data store 585. As shown, the various information handling systems can be networked together using computer network 500. In an embodiment, mobile phone 510 may support internet connectivity and utilize interface such as an Application Programming Interface (API) supported by server 560. In an embodiment, the server 560 or a service supplied as an application on the server may support a request unique session id interface to support an embodiment of the invention disclosed herein. Other computing systems may also include similar data transferring processing support.

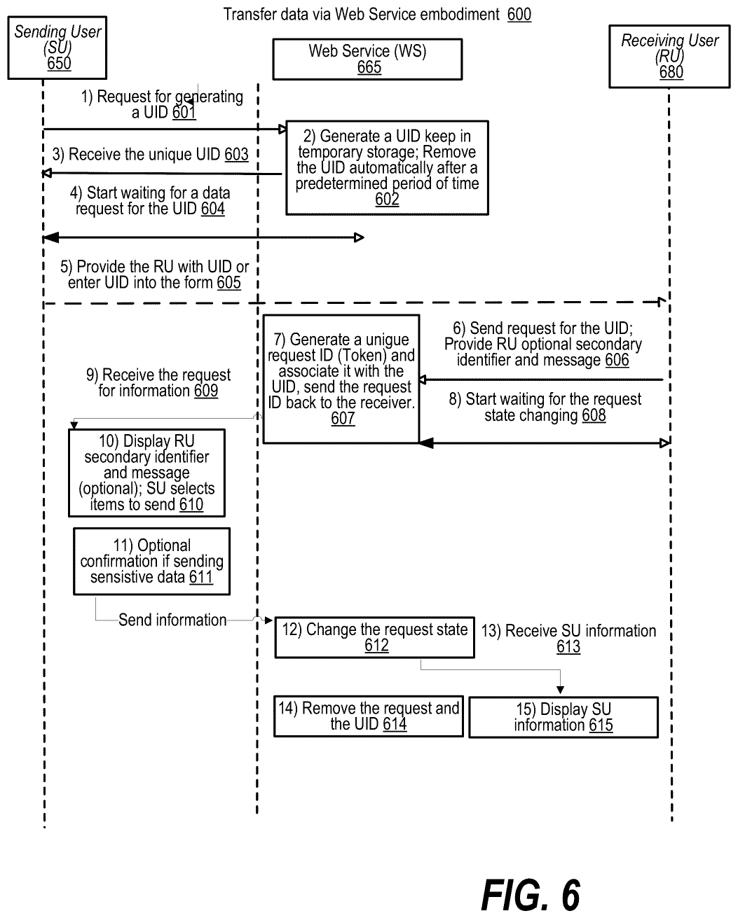

FIG. 6 depicts a transfer data via Web Service embodiment 600 for securely sharing information between two users using a single UID. At step 601, the Sending User (SU) 650 initiates a transaction from an application (i.e., app, web page form, etc.) menu. As mentioned previously, the term “SU” utilizes GNB as needed on the sender's machine and the term “RU” utilizes GNB as needed on the receiver's machine. GNB sends a request for generating a unique identifier (UID) to the Web Service (WS) 655. The term “WS” also implies utilizing GNB as needed on the Web Service machine. At step 602, the WS generates UID, assigns this UID to the transaction and keeps it in its temporary storage with the status “pending.” The WS cleans the temporary storage by removing disposable numbers that are older than predetermined amount of time. At step 603, the SU app shows the “Please wait” dialog while connecting to the web service and receiving disposable UID. Having received a valid disposable UID at step 604, the app displays the “Waiting for request” dialog to the SU while querying the WS every second (or another pre-determined period of time) checking the status of the UID in background. If there is no change in the UID status after the pre-determined period of time has expired, the app cancels the transaction and sends the web service the cancel command that removes the UID from the temporary storage on the web service. If SU clicks “Cancel Transaction” button while waiting then the transaction cancels and the app sends the web service the cancel command. WS may also cancel and dispose the UID without receiving any command from the app after pre-determined period of time. At step 605, the SU provides the UID to the Receiving User (RU) 680 or enters it into the form. If the SU is using the UID, for example, to purchase an item online then SU and RU can be the same person. There are other multiple scenarios when the SU and RU is the same person: when a user is transferring information from one of their devices to another, when a user desires to post something on a web forum from one of their devices etc. At step 606, the RU enters the UID provided by the SU into the form on their app, a web page, or any other device networked with the WS along with RU secondary identifier (name, number, picture, or anything else that would enable the SU to verify that RU is an intended recipient of the information). The RU may also enter a message at this stage. When the RU submits the form, the request containing the UID (provided by the Sender), that can include an optional RU secondary identifier or an optional message is sent to the WS. The second identifier is transmitted to the end-point device of the SU along with the query and displayed on said sending user networked device. In this way, the SU can verify that RU is the intended recipient of the information. At step 607, the WS checks if the UID submitted by the RU exists and that the UID is not in use by another transaction. If the UID exists and is available for the transaction, the WS generates a unique request ID (Token), associates it with the UID and changes the UID status to “reserved” to prevent using the UID in another transaction. If the UID does not exist, the UID is already processed or in use by another transaction then the WS responds with an error. At step 608, the RU app receives back the Token. The RU app begins querying the WS in the background waiting until the SU information becomes available at the WS and is associated with Token. The web app may be configured so that the waiting time would be limited. In this case the web app cancels the request if a timeout occurs. At step 609, the SU app determines that the status of the UID at the WS is changed to “reserved” and retrieves a RU secondary identifier and the message, if available. At step 610, the SU app displays the RU secondary identifier and message to the user if they are provided (if not provided, displays “unknown”) letting the SU know that the RU is ready to accept information and prompts the SU to select information to be sent to the RU. If there is sensitive data selected to send then the app displays a warning and requests the user's confirmation. The user can cancel the transaction. At step 611, If the SU authorizes information transfer, the app forwards SU information to the WS. At step 612, the WS associates the SU information with the Token and changes the UID status to “available.” At step 613, the RU app determines that the SU information became associated with the Token, retrieves this information to the RU and exits a polling cycle. At step 614, the UID status is changed to “completed” and the UID, Token and the associated information is removed from the WS. At step 615, the RU app displays information received from the SU or a diagnostic message if the SU has canceled the transaction.

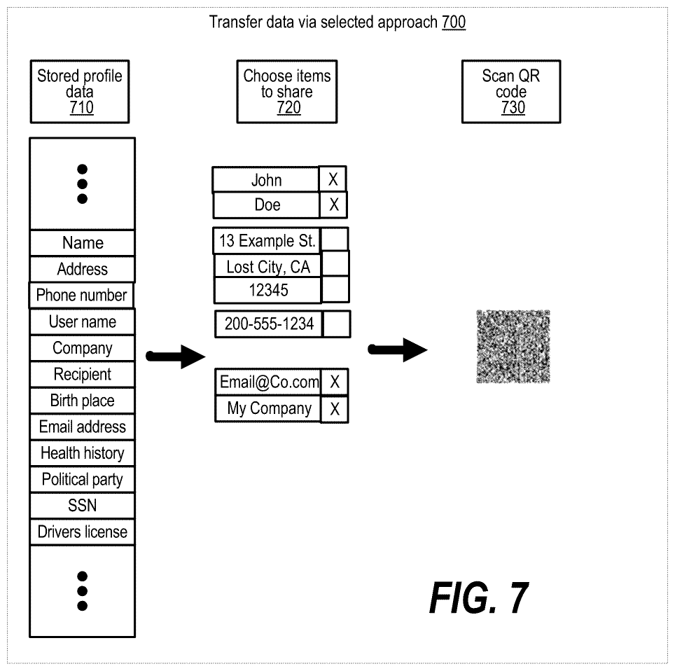

FIG. 7 depicts a schematic view of transferring data without using a network 700. Profile data 710 is stored in an existing profile for the user. Running the GNB application, the user is presented with the ability to select or mark individual entries in profile 720 to be shared. After selecting all the entries to be shared, the user indicates that the selections are made and may be shared. Then GNB constructs a QR code 730 from the shared entries. The user may then share the QR code with an intended recipient. The user may also save the selected group of entries and store it on the phone with an assigned name to share later omitting the initial step of selecting items from the profile.

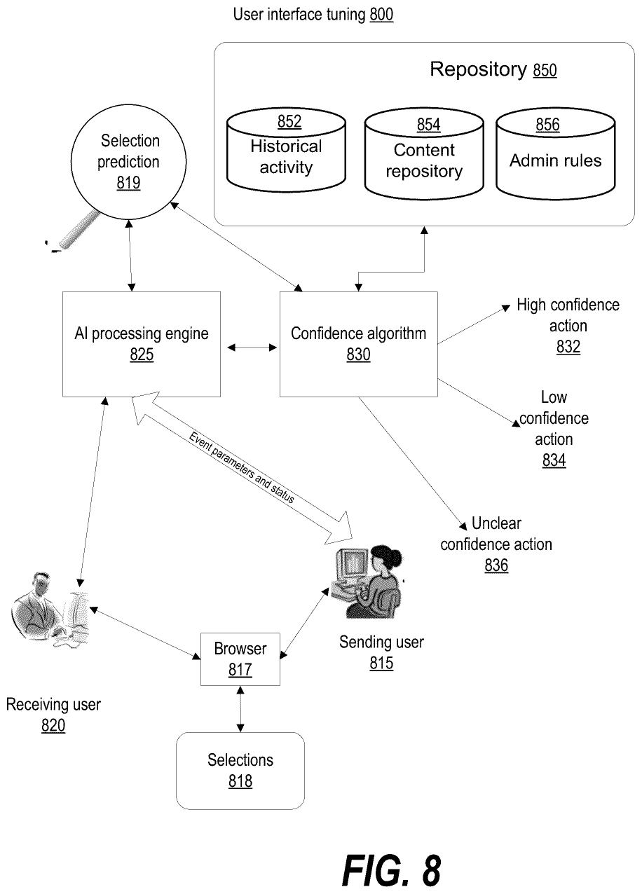

FIG. 8 depicts an embodiment of an artificial intelligence (AI) selection prediction model 800. Often the type of receiving user identifies the information needed to be sent. For example, if communicating with a doctor's office an established patent typically needs to provide a name and a birthdate. However, an initial registration with a doctor's office typically needs significantly more information besides name and birthdate, for example, insurance information, past surgeries, current medications, and etc. If dealing with a credit card company, typically, a social security number is required. Once the type of receiving user is identified, the prediction model may be used to find matching cases to determine a statistical success rate for a successful outcome of making a related selection. The testing parameters 819 are identified for the selection. The testing parameters 819 may include a minimum number of people to be tested, a minimum number of professionals or provider types to support the testing, and a prediction status which may be determined by a client 815 making the selection via any of the communication technologies. The repository 850 may be a database management system (DBMS) supporting indexing, queries, and other typical database features. It could be any data store for recording and retrieving data. The repository 850 may include various elements, for example, but not limited to, historical activity 852 that records a history of selections held with new selections added as needed, a content repository 854, that identifies, for example, history of previously determined selections or attempts at selection, and admin rules 856 that may determine policies for capturing information, overriding previously entered information, and the like. The repository 850 may have default rules for capturing factors affecting selection. The repository 850 may be adaptive and may automatically adjust based on feedback via artificial intelligence (AI) technology. Although the user interface depicted in FIG. 8 is browser 817, any user interface may be used. The user interface may provide a GUI where the user inputs parameters as menu entries, command line entries, scripts entries, configuration files, .xml files, or any other means of providing the required information.

The AI processing engine 825 uses confidence algorithm 830 to access the repository 850 and to characterize the parameters 819. The analysis selection 820 using human feedback may be tied to the confidence algorithm 830 that formulates queries against the repository 850 to determine comparable factors in other selection processing cases. The historical activity 852 may be retrieved as well as the information from the content repository 854 to find associations between a current selection processing case and previous selection processing case histories. Natural language processing (NLP) may be applied to the historical activity 852, to make the association. Deep analytic analysis and artificial intelligence technologies may be used to adjust the categorization. Feedback from Subject Matter Experts (SMEs), and other user feedback may be used to tune the characterization and form a confidence level or ranking to a previous selection processing. Selections may be made via analysis selection 820. Human feedback may also be used to update the selection parameters 818. The illustrative embodiment is based on a predicted improvement of the selection processing case matching based on the confidence algorithm 830. If the confidence is high that the parameters match a set of selection processing, the high confidence action 832 may add the match to the content repository 854. In which case, statistics for the current case may be tracked and added to an existing entry. If the confidence is low, that the parameters match a previous set of selection, a low confidence action 834 is taken. The low confidence action 834 may be an indication that no match found. In that case, a new selection case may be added to the content repository 854. If the confidence is unclear, an unclear confidence action 836 may be taken to request more clarification and the information may be added to the content repository 854 as information to be gathered.

It is appreciated the use of a UID as part of an inventive information exchange provided a business with statistical data to evaluate customer service transactions. Statistics can be of benefit to evaluation aspects such as time devoted to a given customer transaction, success rate of customer transaction to resolve issues, comparison between phone operator and web-based transactions, and usage of the inventive process relative to conventional processes.

The present invention is further detailed with respect to the following non-limiting examples. These examples illustrate specific relationships between customer service and a customer, and algorithms according to the present invention. It is appreciated that the present invention is not limited to customer support.

### Example 1

Customer (SU) makes a telephone call to customer support and provides a UID. Customer support (RU) enters the UID into the web form and this triggers a request to the customer's “fixed” information, such as name, email, address, credit card or bank account information, insurance number, web site login, file, as well as their location (for example for a roadside emergency service). The customer (SU) selects which information to send and authorizes sending information (after receiving notification or by starting an application). This use case can be completely automated, wherein the customer can enter their number on a dial pad when prompted to do that by an automated outgoing recording.

### Algorithm

The customer (SU) installs an app on a multimedia device, and then completes the fillable fields with information (e.g., one or more of name, product code of purchase, customer number, email, credit card number, etc.). While on the telephone call with customer support (RU), the UID is created for the SU device, and is registered in the central database and becomes unavailable to others. The SU provides the UID to the RU, who enters the UID into the form (a request is sent to the central database). It is appreciated that this step can be completely automated on a business side by offering the SU an option to enter their UID after an automated voice prompt. The SU receives a request for information which identifies the RU as a receiver. The SU then authorizes the uploading of information that the SU selects. The RU web form, routinely queries the centralized database for the customer's reply to determine that such a reply is available. When the information is available on the database, the data then transfers into the RU web form. Customer supplied information, or a subset of such information, is then displayed to the RU. The web form can export data into other formats convenient for customer support. It is appreciated that this algorithm is also operative for any two users, when a call is made to a land line or for any other reasons text messaging or email use is not practical. RU may be required to register before being able to receive SU information.

Example 1 may have a provision that a disposable UID is generated and is expunged from the database along with sent information (if uploaded) once the transaction is completed or a preselected time has lapsed. Here, the customer (RU) makes a telephone call to support and selects on their multimedia device application the data items they want to send, and then their phone app generates a UID number that is either disposable or permanent. The customer (RU) then provides their UID to the customer support (SU). Once support transfers information, temporary the UID disappears from the system in certain embodiments and can be recycled for another transaction, or else the UID is retained with a customer association.

In a payment transaction, between a sending user networked device of a sending user (SU) and a receiving user (RU), payment information is entered and stored on the sending user networked device. The sending user networked device is registered in a networked database by issuance of a Unique ID (UID) for the transaction, which is reserved and unavailable to other while the transaction is pending. The UID is displayed on the sending user networked device, and then supplied to the RU orally via phone or in person. The RU then enters the UID into a receiving user end-point device or a web browser connected to the database thereby creating an authorization query to the sending user networked device. The query is then displayed on the sending user networked device. The SU then authorizes the transmission of payment information to the complete the transaction from the sending user networked device. While electronic payment information is transmitted to the RU, it is appreciated that such information is readily protected so as not to be seen by the RU through encryption or other techniques conventional to the art. RU in some embodiments also enters an amount to be paid and then transmits the amount to be paid to the sending user networked device of the SU. In the case of certain financial transactions, the RU may be able to see SU name and shipping address, but not the credit card information. In this example, financial information will only be seen by credit card processing company.

With the UID being a front form the transaction, credit card information can be kept hidden and secure from a merchant whether paying online or in person at a point of sale. To accomplish this, the UID can be loaded in the form that is submitted to the payment gateway (i.e., Authorize.net) in such way that the merchant can never see the details of the payment vehicle (i.e., credit card). Payment information illustratively includes a debit card, credit card, a bit coin, or a bank draft. To protect the SU payment information, the RU can be an approved merchant who has been vetted and verified. In still other embodiments, information about the RU the is displayed on the sending user networked device as a part of the query.

In case of financial transaction, the query to the SU may contain the amount to be charged, merchant ID and other information required to facilitate the transaction. Alternatively, the amount to be charged may be entered by the SU before authorizing the transaction.

In some embodiments, the same person can act as both, SU and RU. For example, while making a payment on the web site or logging into the web site or completing a form on the web site. First the person acts as a SU generating the UID, then acts as a RU by entering the generated UID into the respective form and then again as a SU by authorizing information transfer from his end-point device.

### Example 2

While on the phone, the customer (RU) requests that their appointment information be sent to them by a healthcare provider's office (SU). The RU provides the SU with a UID. The SU enters the RU's UID into the appointment form along with appointment information. The appointment information then arrives to the RU mobile device.

The algorithm of Example 1 is used herein with the proviso that the query for information sent from the customer support includes appointment information (or any other information that customer requested). Since no information is actually requested from the customer, they do not have to perform any actions to accept the query and this completes the transaction.

### Example 3

A customer when searching for a business on a desktop PC and jumping into the car to drive to the business, rather than emailing found business information to himself or jotting the information onto a piece of paper, the customer (SU) gets information using UID of a business of interest. A given business or individual or an event is registered for a UID and the UID has linked information that illustratively includes one or more of address, phone, hours of operation, current promotion, or combinations thereof. The UID linked information resides in the database, and in some embodiments only enters the database for a transient single usage. In still other embodiments, the business does have an option to store UID linked information on the customer end-point device. No authorization by a business is required to retrieve UID linked information by customer.

The UID is published on the business web site along the phone number. In this way, a customer looking for business information enters the UID of the business into their UID application on an end-point device (or a web form) and this transfers business information into their UID application (or web form). In another inventive embodiment, a script is provided on a business web site where a customer enters their UID and the business information is sent to their end-point device application.

### Algorithm

The business registers on a UID network and is issued a UID to share with customers or potential customers. The business also completes a form providing information to be transferred to the customer when the business UID is queried. A customer runs a UID application on the multimedia device, and enters the business unique UID. This situation results in a query to the database being generated and business information being transferred to customer's multimedia device.

An alternative algorithm embodiment has a customer access the business web site and enters his (customer's) UID into the form where the business of interest UID is already preloaded, resulting in query containing business information being sent to the central database with customer's UID. A customer UID application then retrieves data from the query containing business's information on a customer end-point device.

The present invention also affords a method for contact information and promotions to a mobile device of a user to be communicated by a business to an end user by creating an online contact card containing contact information and promotions. A number or a word by way of example is chosen as a handle to access the contact card. A user installing a software application on the mobile device retrieves the contact card using the number or the word as a handle. The handle is then used to keep information on the mobile device up-to-date by creating a periodic request to the said contact card.

It is appreciated that information transfer in this case or any other use case can be a computer file. It is further appreciated that as an alternative to a centralized database to store information waiting for query, such queries may be organized as a pipe that merely relates information between two end-point devices.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the described embodiments in any way. Rather, the foregoing detailed description will provide those skilled in the art with a convenient road map for implementing the exemplary embodiment or exemplary embodiments. It should be understood that various changes can be made in the function and arrangement of elements without departing from the scope as set forth in the appended claims and the legal equivalents thereof.

The foregoing description is illustrative of particular embodiments of the invention but is not meant to be a limitation upon the practice thereof. The following claims, including all equivalents thereof, are intended to define the scope of the invention.

In an embodiment, an approach is disclosed for sending data between a first device and a second device. A connection is established connection between the first device and a web service. The first device requests a unique session ID to be issued and stored by the web service. The unique session ID is received by the first device from the web service. The unique session is communicated from the first device to the second device. The first device waits for a notification form the web service, that the unique session ID from the second device has been received. The first device receives the notification, from the web service identifying the data on the first device to be sent to the second device. The identified data is sent to the second device. The information received by the first device may include an identification of a user of the second device. The communication of the unique session ID may be via a bar code. A predetermined period of time may be established for the waiting for the notification. After detecting the predetermined period of time and an absence of the notification, releasing the unique session ID. The unique session ID may be released after sending the identified data. Data is sent between a first device and a second device.

In an embodiment, a connection is established between the first device and a web service. A unique session ID is requested to be issued and stored by the web service. The unique session ID is received by the first device from the web service. The unique session ID is communicated from the first device to the second device. The first device waits for a notification from the web service that the unique session ID from the second device has been received. The first device receives the notification that the unique session ID from the second device is received, from the web service. The identified data on the first device is sent to the second device. In some embodiments, in addition to the unique session ID, secondary identifying information identifying a second device user may be transmitted. The unique session ID may be transmitted using bar code (QR code) and the waiting period may be predetermined. 5. Once the data is transmitted the web service releases the unique session ID and all other transaction related data.

A method for exchanging information between a first party and a second party is disclosed. The placeholder with information line-items is selected. The mode of transmission is selected with or without Internet, Items are selected from the placeholder to be transmitted. A QR code is generated depending on the chosen mode of transmission. The QR code is provided to the receiving device, The selected information is transmitted to the receiving device. In the Internetless mode, QR code embeds (sell-contains) line items.

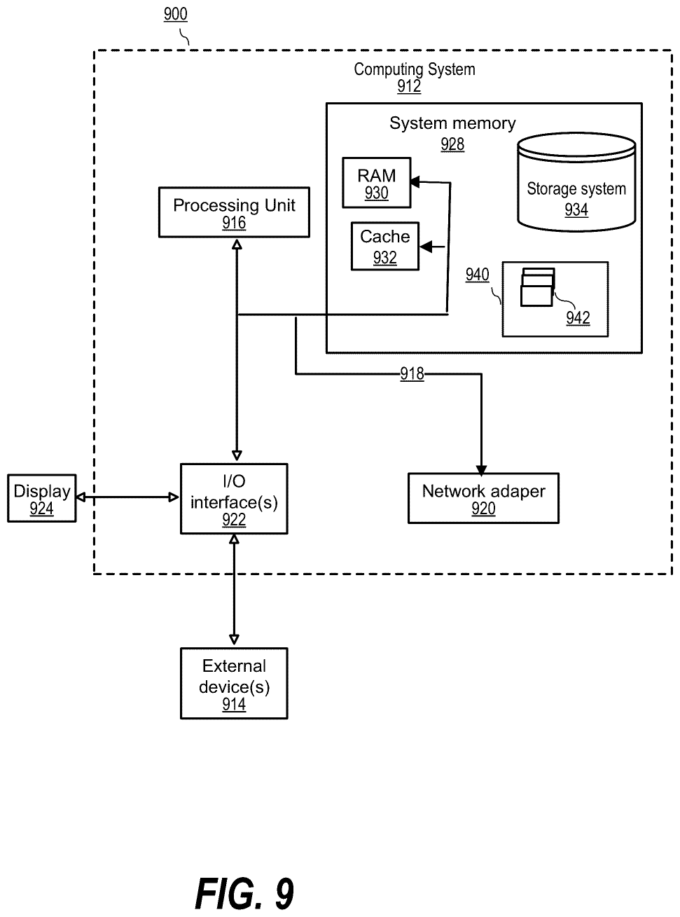

Referring to FIG. 9, a schematic view of a processing system 900 is shown wherein the methods of this invention may be implemented. The processing system 900 is only one example of a suitable system and is not intended to suggest any limitation as to the scope of use or functionality of embodiments of the invention described herein. Regardless, the system 900 can implement and/or performing any of the functionality set forth herein. In the system 900 there is a computer system 912, which is operational with numerous other general purpose or special purpose computing system environments or configurations. Examples of well-known computing systems, environments, and/or configurations that may be suitable for use with the computer system 912 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system 912 may be described in the general context of computer system-executable instructions, such as program modules, being executed by a computer system. Generally, program modules may include routines, programs, objects, components, logic, data structures, and so on that perform tasks or implement abstract data types. The computer system 912 may be practiced in distributed cloud computing environments where tasks are performed by remote processing devices that are linked through a communications network. In a distributed cloud computing environment, program modules may be in both local and remote computer system storage media including memory storage devices.

As shown in FIG. 9, the computer system 912 in the system environment 900 is shown in the form of a general-purpose computing device. The components of the computer system 912 may include, but are not limited to, a set of one or more processors or processing units 916, a system memory 928, and a bus 918 that couples various system components including the system memory 928 to the processor 916.

The bus 918 represents one or more of any of several types of bus structures, including a memory bus or memory controller, a peripheral bus, an accelerated graphics port, and a processor or local bus using any of a variety of bus architectures. By way of example, and not limitation, such architectures include the Industry Standard Architecture (ISA) bus, the Micro Channel Architecture (MCA) bus, the Enhanced ISA (EISA) bus, the Video Electronics Standards Association (VESA) local bus, and the Peripheral Component Interconnects (PCI) bus.

The computer system 912 typically includes a variety of computer system readable media. Such media may be any available media that is accessible by the computer system 912, and it includes both volatile and non-volatile media, removable and non-removable media.

The system memory 928 can include computer system readable media in the form of volatile memory, such as random-access memory (RAM) 930 and/or a cache memory 932. The computer system 912 may further include other removable/non-removable, volatile/non-volatile computer system storage media. By way of example only, a storage system 934 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus 918 by one or more data media interfaces. As will be further depicted and described below, the system memory 928 may include at least one program product having a set (e.g., at least one) of program modules 942 that are configured to carry out the functions of embodiments of the invention.

A program/utility 940, having the set (at least one) of program modules 942, may be stored in the system memory 928 by way of example, and not limitation, as well as an operating system, one or more application programs, other program modules, and program data. Each of the operating systems may have one or more application programs, other program modules, and program data or some combination thereof, and may include an implementation of a networking environment. The program modules 942 generally carry out the functions and/or methodologies of embodiments of the invention as described herein.

The computer system 912 may also communicate with a set of one or more external devices 914 such as a keyboard, a pointing device, a display 924, a tablet, a digital pen, etc. wherein these one or more devices enable a user to interact with the computer system 912; and/or any devices (e.g., network card, modem, etc.) that enable the computer system 912 to communicate with one or more other computing devices. Such communication can occur via Input/Output (I/O) interfaces 922. These include wireless devices and other devices that may be connected to the computer system 912, such as, a USB port, which may be used by a tablet device (not shown). Still yet, the computer system 912 can communicate with one or more networks such as a local area network (LAN), a general wide area network (WAN), and/or a public network (e.g., the Internet) via a network adapter 920. As depicted, a network adapter 920 communicates with the other components of the computer system 912 via the bus 918. It should be understood that although not shown, other hardware and/or software components could be used in conjunction with the computer system 912. Examples include, but are not limited to microcode, device drivers, redundant processing units, external disk drive arrays, RAID systems, tape drives, and data archival storage systems, etc.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While particular embodiments have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method for transmitting data between a first device and a second device comprising:
selecting entries from a dataset on the first device;
embedding a representation of the selected entries into an image;
scanning the image by a camera on the second device;
decoding the scanned image by the second device to extract the representation of the selected entries; and
storing the representation of the selected entries on the second device.

2. The method of claim 1, wherein the dataset further comprises:
contact information.

3. The method of claim 2, wherein the contact information is selected from a group consisting of a name, an address, and an email address.

4. The method of claim 3, wherein the selected entries are stored in a contact list.

5. The method of claim 1, wherein an entry in the dataset has a label indicating a transfer criteria.

6. The method of claim 5, wherein the transfer criteria indicates an application presence on the second device.

7. The method of claim 1, wherein the image is a quick response (QR) code.

8. The method of claim 1, wherein the image is stored on the first device.

9. An information handling system for transmitting data between a first device and a second device comprising:
one or more processors;
a memory coupled to at least one of the processors;
a network interface that connects the local device to one or more remote web sites; and
a set of computer program instructions stored in the memory and executed by at least one of the processors in order to perform actions comprising:
selecting entries from a dataset on the first device;
embedding a representation of the selected entries into an image;
scanning the image by a camera on the second device;
decoding the scanned image by the second device to extract the representation of the selected entries; and
storing the representation of the selected entries on the second device.

10. The information handling system of claim 9, wherein the dataset further comprises:
contact information.

11. The information handling system of claim 10, wherein the contact information is selected from a group consisting of a name, an address, and an email address.

12. The information handling system of claim 11, wherein the selected entries are stored in a contact list.

13. The information handling system of claim 9, wherein an entry in the dataset has a label indicating a transfer criteria.

14. The information handling system of claim 13, wherein the transfer criteria indicates an application presence on the second device.

15. A computer program product stored in a computer readable storage medium, comprising computer program code for transmitting data between a first device and a second device that, when executed by the computer program product, performs actions comprising:
selecting entries from a dataset on the first device;
embedding a representation of the selected entries into an image;
scanning the image by a camera on the second device;
decoding the scanned image by the second device to extract the representation of the selected entries; and
storing the representation of the selected entries on the second device.

16. The computer program product of claim 15, wherein the dataset further comprises:
contact information.

17. The computer program product of claim 16, wherein the contact information is selected from a group consisting of a name, an address, and an email address.

18. The computer program product of claim 17, wherein the selected entries are stored in a contact list.

19. The computer program product of claim 15, wherein an entry in the dataset has a label indicating a transfer criteria.

20. The computer program product of claim 15, wherein the transfer criteria indicates an application presence on the second device.
